(19) United States
(12) Patent Application Publication
(10) Pub. No.: US 2019/0203629 A1
(43) Pub. Date: Jul. 4, 2019

(54) METHOD AND DEVICE FOR THE EXHAUST GAS AFTERTREATMENT OF AN INTERNAL COMBUSTION ENGINE

(71) Applicant: Volkswagen Aktiengesellschaft, Wolfsburg (DE)

(72) Inventor: Florian ZINK, Bad Rappenau (DE)

(73) Assignee: Volkswagen Aktiengesellschaft, Wolfsburg (DE)

(21) Appl. No.: 16/312,044

(22) PCT Filed: Jun. 19, 2017
(86) PCT No.: PCT/EP2017/064874

§ 371 Date: Dec. 20, 2018

(30) Foreign Application Priority Data
Jun. 23, 2016 (DE) 10 2016 211 274.0

(51) Int. Cl. F01N 11/00; F01N 3/20; F01N 9/00; F01N 3/10

(52) U.S. Cl. CPC F01N 11/002; F01N 3/2006; G01M 15/104; F01N 3/101; F01N 9/00

(57) ABSTRACT

The invention relates to a method for exhaust treatment of an internal combustion engine, in particular for regeneration of a particle filter in the exhaust gas duct of an internal combustion engine, wherein the particle filter becomes loaded with soot particles during normal operation of the internal combustion engine. To reach the regeneration temperature of the particle filter, the internal combustion engine is operated with a rich fuel mixture, while secondary air is being introduced into the exhaust gas duct at the same time, and the unburned fuel components are reacted exothermically with the secondary air on the particle filter until the particle filter has heated up to the regeneration temperature. Once the regeneration temperature has been reached, the internal combustion engine is operated at a stoichiometric combustion air ratio, and secondary air is injected into the exhaust gas duct for oxidation of the soot particles retained in the particle filter, wherein control of the amount of secondary air is accomplished by means of a lambda probe downstream from an introduction point for the secondary air and upstream from the particle filter.

The invention relates to a method and device for THE exhaust gas aftertreatment of an internal combustion engine.

More stringent standards for regulating exhaust emissions have made high demands of automobile manufacturers, requiring solutions in the form of appropriate measures for reducing crude engine emissions and an appropriate exhaust gas aftertreatment. With the introduction of the next Euro 6 legislative standard, a particle count limit will also be stipulated for internal combustion engines. This may mean that a particle filter for gasoline engines may be necessary on some models. Such an exhaust particle filter becomes loaded with soot during driving operation. In order for the exhaust gas counterpressure not to increase too much, this exhaust particle filter must be regenerated continuously or periodically. To achieve thermal oxidation of the soot retained in the exhaust particle filter by using oxygen, it is necessary to have a sufficiently high temperature level in combination with the simultaneous presence of oxygen in the exhaust system of the internal combustion engine. The soot retained in the particle filter can therefore be oxidized in this way. Since modern internal combustion engines are normally operated with a stoichiometric combustion air ratio (λ=1) without an excess of oxygen, so that additional measures are required. Oxygen is usually introduced into the exhaust gas duct when the internal combustion engine is coasting, i.e., when no fuel is being injected into the combustion chambers. Alternatively, a temporary lean adjustment of the internal combustion engine or injection of secondary air into the exhaust system, for example, may be considered. So far, preference has been given to a lean adjustment of the internal combustion engine because this method does not require the use of any additional components, and it can provide a sufficient amount of oxygen during most operating phases of an internal combustion engine. A complex sensor system is required for monitoring and controlling regeneration. However, one disadvantage of such a lean adjustment is that the regeneration temperature required for regeneration of the particle filter is not achieved in low partial-load operation or in short-distance trips. Furthermore, nitrogen oxides cannot be converted adequately by the three-way catalyst when the engine is operating with a lean mixture, because no reducing agents are available for the nitrogen oxides.

DE 10 2010 044 102 A1 discloses a method for exhaust gas aftertreatment of an internal combustion engine, in which the internal combustion engine is operated with stoichiometric combustion air during regeneration of the particle filter, and secondary air is injected into the exhaust gas duct for regeneration of the particle filter. The amount of secondary air here is introduced into the exhaust gas duct through a passive flutter valve, so that quantitative control of the amount of secondary air is impossible.

DE 10 2011 002 438 A1 discloses a method for determining the loading of a particle filter in the exhaust gas duct of an internal combustion engine, wherein secondary air is introduced into the exhaust gas duct upstream from the particle filter during operating states of the internal combustion engine when the volume of exhaust gas is low. This is done in order to increase the volume flow and thereby improve the result of a differential pressure measurement, on the basis of which the load condition of the particle filter is calculated.

DE 10 2013 220 899 A1 discloses a method for regeneration of a particle filter in the exhaust gas duct of an internal combustion engine, wherein the particle filter is heated by engine measures involving the internal combustion engine, and wherein the particle filter is supplied with soot particles retained in the filter for oxidation by the residual oxygen of a lean internal combustion mixture of the internal combustion engine, such that the amount of residual oxygen is regulated by lambda control of the internal combustion engine for oxidation of the soot on the particle filter.

The invention is now based on the object of providing a method and a device, with which a sufficiently high temperature level for regeneration of the particle filter is achieved and also the pollution emissions are minimized even during regeneration of the particle filter, so that regeneration of the particle filter can take place in an essentially emission-neutral manner.

This object is achieved by a method for exhaust gas aftertreatment of an internal combustion engine having an exhaust gas duct as well as a three-way catalyst arranged in the exhaust gas duct and a particle filter arranged downstream from the three-way catalyst, said method comprising the following steps:
operation of the internal combustion engine with a stoichiometric combustion air ratio, with the soot particles generated by combustion being retained in the particle filter,
ascertaining the load condition of the particle filter,
initiating regeneration of the particle filter when the need for regeneration of the particle filter is recognized by ascertaining the load status,
raising the exhaust gas temperature by operating the internal combustion engine with a rich combustion air ratio below the stoichiometric ratio and simultaneously introducing secondary air into the exhaust gas duct upstream from the particle filter, so that the unburned fuel components are reacted exothermically with the secondary air in the exhaust gas duct or on the particle filter,
regeneration of the particle filter, so that the internal combustion engine is operated with a stoichiometric combustion air ratio, and secondary air is introduced into the exhaust gas duct, and
the amount of secondary air introduced into the exhaust gas duct is regulated by a lambda probe downstream from the introduction point for the secondary air and upstream from the particle filter.

Due to the method according to the invention, the particle filter can also be heated to a regeneration temperature, even at a low partial load or in short-term operation, and then regenerated. Lambda control can be used in this process, so that too much oxygen does not enter the exhaust gas duct and thereby allow uncontrolled burn-off of the soot and the associated thermal damage to the particle filter. Using a lambda probe instead of pressure sensors and/or temperature sensors has the advantage that the quality of the mixture can be evaluated directly in the exhaust gas duct upstream from the particle filter.

Due to the measures described in the dependent claims, advantageous refinements and improvements on the method described in the independent claim for regeneration of the particle filter are possible.

In a preferred embodiment of the invention, it is provided that a stoichiometric air mixing ratio in the exhaust gas duct is adjusted downstream from the three-way catalyst and upstream from the particle filter by introducing secondary air during the heating phase. The amount of secondary air can therefore be adjusted so that unburned fuel components can be reacted completely with oxygen from the secondary air supply in the exhaust gas duct and/or on the particle filter during the heating phase of the particle filter, so that emissions of carbon monoxide (CO) and unburned hydrocarbons (HC) are not increased, even during the heating phase.

In a preferred embodiment of the method, it is provided that the temperature of the particle filter is ascertained, and in the regeneration phase, the temperature is kept above the regeneration temperature of the particle filter. The particle filter can be regenerated in a continuous process in this way until all the soot loading of the particle filter has been oxidized. This prevents a residual load on the particle filter, which would necessitate more frequent regeneration cycles and therefore increased fuel consumption by the internal combustion engine.

In another preferred embodiment of the invention, it is provided that the introduction of secondary air is stopped on reaching an upper threshold temperature of the particle filter. By stopping the input of secondary air, exothermic oxidation of the soot particles retained in the particle filter is also stopped, so that further heating of the particle filter can be prevented. Therefore, lambda control of the secondary air can make an effective contribution to component protection of the particle filter.

It is especially preferable if the amount of secondary air dosed into the exhaust gas duct is increased or decreased as a function of the change in temperature of the particle filter. In doing so, the amount of secondary air is throttled when there is a rise in the temperature of the particle filter during regeneration of the particle filter until the temperature stops rising. If the temperature of the particle filter drops, the amount of secondary air is increased during regeneration in order to increase the conversion of soot by oxidation on the particle filter and to stabilize or increase the temperature of the particle filter through this exothermic reaction, so that the temperature of the particle filter does not drop below the regeneration temperature during regeneration and no further soot particles can be oxidized.

Alternatively or additionally, it is provided that the amount of secondary air introduced into the exhaust gas duct is increased with an increase in regeneration of the particle filter and a decrease in the degree of loading of the particle filter. In particular in the case of heavily loaded particle filters and high exhaust gas temperatures, there is the risk that an excessively high oxygen concentration in the exhaust gas duct may lead to uncontrolled burn-off of soot on the particle filter and therefore cause thermal damage to the particle filter. The lower the loading of the particle filter, the lower is the further oxidation of soot particles retained in the particle filter. In order for the reaction rate not to drop too much at the end of the regeneration process and for the temperature of the particle filter not to drop below the regeneration temperature, the amount of oxygen can be increased through additional secondary air in the course of regeneration.

Alternatively, it is advantageously provided that it is possible to switch repeatedly between the heating phase and the regeneration phase in order to regenerate the particle filter. It is thus possible to ensure that, on the one hand, there is no overheating or damage to the component during regeneration of the particle filter, and, after the temperature drops below the regeneration temperature, the regeneration process is restarted as often as necessary until complete regeneration of the particle filter has been achieved.

According to one improvement on the method, it is provided that the temperature during regeneration of the particle filter is kept within a temperature window between the regeneration temperature and an upper threshold temperature. In this temperature window, rapid and efficient oxidation of soot particles retained in the particle filter is possible, but the thermal durability of the particle filter is not decreased, which would thus shorten the lifetime of the particle filter.

It is particularly advantageous if the temperature window is in a range of 600° C. to 750° C. Temperatures above 600° C. have proven to be effective for oxidation of the soot particles in existing particle filters. These particle filters can permanently withstand temperatures up to 750° C. without any damage to the particle filter.

According to another improvement in the method, it is provided that the amount of secondary air is regulated, so that an air mixing ratio upstream from the particle filter of λ_{M}=1.05 to 1.4 is established during regeneration of the particle filter. Therefore, oxidation of the soot retained in the particle filter is possible without uncontrolled burn-off of the soot. A range of 1.1<λ_{M}<1.25 is particularly advantageous because sufficiently high conversion rates in oxidation of soot are achieved in this range in order to ensure rapid regeneration of the particle filter.

In a preferred refinement of the method, it is provided that the amount of secondary air is regulated so that a stoichiometric exhaust is established downstream from the particle filter. In doing so, as much oxygen as needed for stoichiometric oxidation of the soot particles is made available through the introduction of secondary air. Therefore, oxidation of the soot particles can be carried out in an essentially emission-neutral manner and no additional harmful secondary emissions are formed due to regeneration of the particle filter.

According to one advantageous embodiment of the method, it is provided that the heating phase is concluded only when the particle filter has reached a temperature at least 30° C., preferably at least 50° C., above the regeneration temperature of the particle filter. This ensures that, even if exothermic oxidation of soot particles is minor at first, the temperature of the particle filter does not immediately drop back below the regeneration temperature, which would cause regeneration to come to a standstill.

According to a preferred embodiment, it is provided that a secondary air pump is arranged on the secondary air line. A sufficiently great pressure gradient can be achieved through the secondary air pump, even at a low engine load, in order to convey air into the exhaust gas ducts against the exhaust counterpressure. Alternatively, in internal combustion engines with an electrically driven compressor, the secondary air may also be taken from the intake line downstream from the compressor and introduced into the exhaust gas duct. Therefore, in the case of electric engines, it is possible to omit an additional pressure generating device, such as a secondary air pump, and the secondary air can be taken from the intake system of the internal combustion engine.

According to the invention, an apparatus is proposed for exhaust gas aftertreatment of an internal combustion engine, comprising an exhaust gas duct, a three-way catalyst arranged in the exhaust gas duct, a particle filter arranged in the exhaust gas duct downstream from the three-way catalyst, and also comprising a secondary air supply, wherein an introduction point for the secondary air from the secondary air supply is provided between the three-way catalyst and the particle filter, as well as having a first lambda probe, which is arranged upstream from the three-way catalyst and a second lambda probe arranged downstream from the introduction point and upstream from the particle filter, wherein the apparatus is equipped to carry out a method according to the invention.

Additional preferred embodiments of the present invention are derived from the other features defined in the dependent claims.

The various embodiments of the invention defined in this patent application can be combined with one another advantageously, unless otherwise specified in the individual case.

The invention will now be explained in detail in the embodiments based on the accompanying drawings, in which:

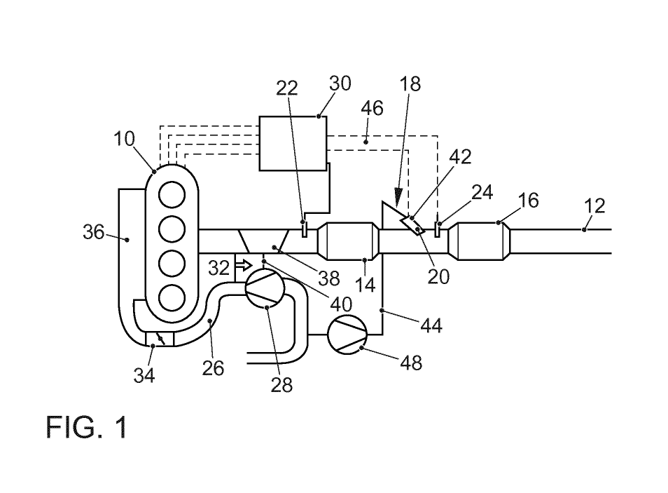

FIG. 1 shows an internal combustion engine having a three-way catalyst and a particle filter arranged downstream from the three-way catalyst as well as a secondary air supply for carrying out a method according to the invention,

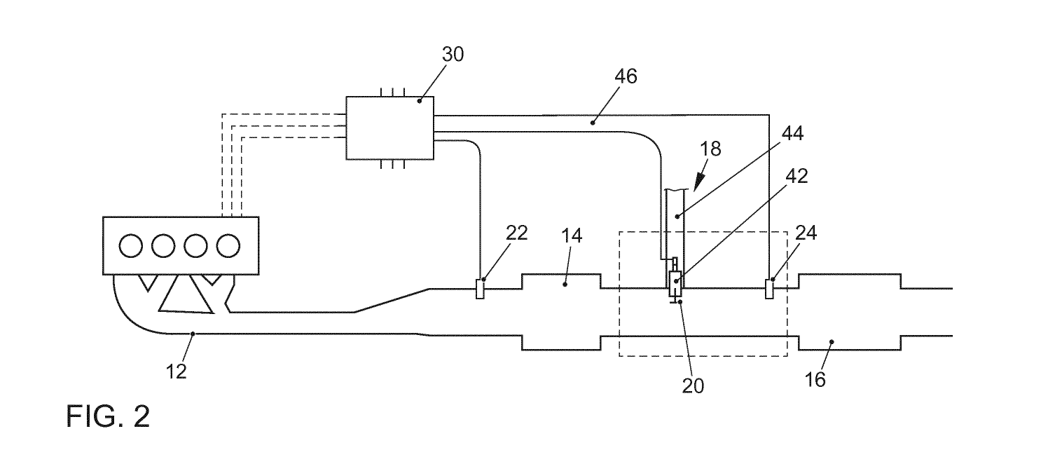

FIG. 2 shows the exhaust gas duct of an internal combustion engine as well as the lambda sensor system for controlling a method according to the invention, and

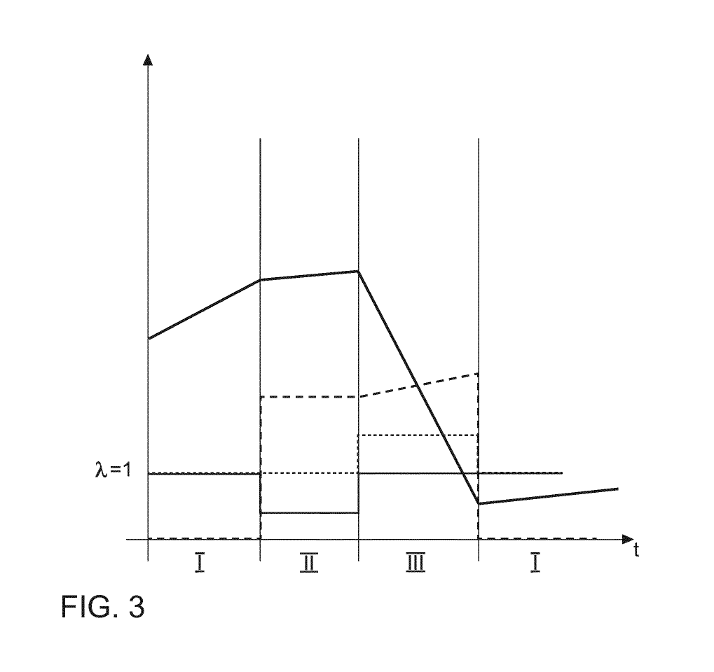

FIG. 3 shows a flowchart of a method according to the invention for regeneration of the particle filter.

FIG. 1 shows an internal combustion engine 10 in the form of a gasoline engine charged with a turbocharger 32, having an intake duct 26 and an exhaust gas duct 12. A compressor 28, a throttle valve 34 and a charge air cooler 36 are arranged in the intake duct 12. A turbine 38 of the turbocharger 32, which drives the compressor 28 of the turbocharger 32 by means of a drive shaft 40, is arranged in the exhaust gas duct 12 in the direction of flow of the exhaust gas of the internal combustion engine 10. Alternatively, the compressor 28 may also be designed as a mechanically driven compressor or as an electric compressor.

A three-way catalyst is arranged in the exhaust gas duct 12 downstream from the turbine 38 in the direction of flow of the exhaust gas of the internal combustion engine 10 through the exhaust gas duct 12. The three-way catalyst 14 here is preferably arranged near the engine to permit rapid heating of the three-way catalyst 14 to a light-off temperature and thus efficient conversion of pollutants. The phrase “an arrangement near the engine” is understood to refer to an arrangement having a central exhaust pathway of max. 50 cm, in particular max. 30 cm, after the outlet of the internal combustion engine 10. Downstream from the three-way catalyst 14, an introduction point 20 for introducing the secondary air into the exhaust gas duct 12 is provided. A secondary air supply 18, comprising a secondary air valve 42 and a secondary air line 44, is connected to the introduction point 20, such that the secondary air line 44 connects a portion of the intake duct 26 downstream from the compressor 28 to the exhaust gas duct 12. A secondary air pump 48, with which an elevated pressure in comparison with the pressure in the exhaust gas duct 12 can be generated, is provided on the secondary air line 44. Alternatively, the secondary air line 44 can also connect the surroundings to the exhaust gas duct 12. In doing so, the secondary air line 44 opens at the secondary air valve 42 and/or the introduction point 20 downstream from the three-way catalyst 14 and upstream from the particle filter 16 in the exhaust gas duct 12. Upstream from the three-way catalyst 14, a first lambda probe 22 with which the combustion air ratio λ_{E} of the internal combustion engine 10 is regulated, is provided in the direction of flow of the exhaust gas of the internal combustion engine 10 through the exhaust gas duct 12. A second lambda probe 24, with which the amount of secondary air introduced into the exhaust gas duct 12 can be controlled by the secondary air valve 42, is provided downstream from the introduction point 20 and upstream from the particle filter 16. In doing so, the first lambda probe 22, the second lambda probe 24 and the secondary air valve 42 are connected via signal lines 46 to a control unit 30 of the internal combustion engine 10 in order to enable regulation of the amount of secondary air injected into the exhaust gas duct 12.

In FIG. 2, the internal combustion engine 10 with the exhaust gas duct 12 is shown in a further simplified diagram. A first lambda probe 22 for controlling the combustion air ratio in internal combustion engine 10 is arranged downstream from the internal combustion engine 10 and upstream from the three-way catalyst 14 in the exhaust gas duct 12. A control circuit for the introduction of secondary air into the exhaust gas duct 12 is situated downstream from the three-way catalyst, wherein the control circuit comprises at least one secondary air supply 18 and a second lambda probe 24 arranged downstream from the introduction point 20 of the secondary air supply 18 and upstream from a particle filter 16.

Soot formed during operation of the internal combustion engine is retained by the particle filter 16, causing the particle filter 16 to become loaded with soot particles from the internal combustion engine 10. A method for regenerating the particle filter 16 is initiated when an established soot loading threshold for the particle filter 16 is detected, which may take place based on a differential pressure measurement upstream and downstream from the particle filter 16, for example, or by means of a model-based calculation. To do so, first the exhaust gas temperature of the internal combustion engine 10 is raised to a regeneration temperature T_{R} of at least 600° C. before entering the particle filter 16. The particle filter 16 preferably has a catalytic coating for exothermically oxidizing unburned hydrocarbons, carbon monoxide and/or hydrogen on the surface of the particle filter 16. First it is necessary to verify whether the particle filter 16 has reached a so-called “light-off temperature” of approx. 350° C. This ensures that unburned constituents of the fuel can be exothermically oxidized out of the exhaust gas of the internal combustion engine 10 on the particle filter 16. If the light-off temperature of the particle filter 16 has been reached, the particle filter 16 is heated further up to the regeneration temperature T_{R}. This is done by operating the internal combustion engine 10 with a rich mixture, which preferably has a combustion air ratio lambda Λ_{E} of approx. 0.9. The unburned constituents of the mixture, in particular carbon monoxide, hydrocarbons and hydrogen, are introduced into the exhaust system 12 together with the combustion products. These unburned constituents of the fuel can be converted exothermically on the downstream particle filter by means of an air intake in the exhaust gas duct 26 downstream from the compressor 28 and by introducing this air into the exhaust gas duct 12 through the secondary air line 44 and the secondary air valve 42. High levels of exhaust gas enthalpy can be introduced into the particle filter 16 through the external air supply via the secondary air supply 18 and by operating the engine with a rich fuel mixture. A complex sensor system, comprising a pressure sensor, a temperature sensor and the second lambda probe 24, is necessary for monitoring and/or regulating this exhaust gas enthalpy. The combustion air ratio λ_{E} of the internal combustion engine 10 can be adjusted by precontrol, so that the desired target temperature is set. At the same time, the air mixing ratio λₘ is measured by the second lambda probe 24 from the combustion air ratio of the internal combustion engine 10 and the secondary air that is introduced downstream from the introduction point 20 and upstream from the particle filter 16. During the heating phase of the particle filter 16, this air mixing ratio is regulated at λₘ=1, so that emissions can be converted on the catalytic coating of the particle filter 16, and the particle filter can achieve its optimum exhaust gas purifying effect.

Once the heating phase is concluded and a temperature above the regeneration temperature T_{R} of the particle filter 18 has been reached, the system switches to a regeneration phase. To do so, the internal combustion engine 10 is again operated at a stoichiometric combustion air ratio λ_{E}=1. Therefore, all the pollutants of the exhaust gas of the internal combustion engine 10 can be reacted completely on the three-way catalyst 14 during the regeneration phase. To supply the oxygen for regeneration of the particle filter 16, secondary air is again introduced into the exhaust gas duct 12. The desired mixing ratio, for example, λₘ=1.1, can be adjusted through corresponding regulation of the secondary air through the secondary air valve 42. This ensures that the conversion rate of the soot retained in the particle filter 16 does not become too high, for example, which could otherwise result in thermal damage to the particle filter 16. If the temperature at the entrance to the particle filter 16 drops during regeneration, then the amount of secondary air is increased to increase the conversion rates of soot retained on the particle filter and thus to increase the exhaust gas temperature T_{EG}. Such regeneration of the particle filter 16 according to the invention is illustrated in FIG. 3. Regeneration of the particle filter 16 is continued until the particle filter 16 is completely regenerated, which can be ascertained by means of a differential pressure measurement or also by means of a calculation model for the soot input and soot output. After complete regeneration of the particle filter 16, the secondary air supply 18 is switched off in a renewed loading phase of the particle filter 16 and the engine as well as the entire exhaust system is again operated with a stoichiometric combustion air mixture λ_{E}=1.

In a first phase I, the internal combustion engine 10 is operated at a stoichiometric combustion air ratio λ_{E}=1, and soot particles are retained in the particle filter 16. Then the secondary air supply 18 is switched off and no further oxygen is introduced into the exhaust gas duct 12 of the internal combustion engine 10. In a second phase II, which is also referred to as the heating phase, the external air supply through the secondary air supply 18 is activated, and the internal combustion engine 10 is operated at a rich combustion air ratio λ_{E}<1, which is below the stoichiometric ratio, so that a stoichiometric air mixing ratio λ_{M}=1 is established downstream from the introduction point 20.

In a third phase III, which is also referred to as the regeneration phase, the internal combustion engine 10 is operated at a stoichiometric combustion air ratio λ_{E}=1, and the introduction of secondary air is increased continuously until the particle filter 16 is completely regenerated. In doing so, a lean air mixing ratio λ_{M}>1, which is greater than the stoichiometric ratio, is established in the exhaust gas duct 12 downstream from the introduction point 20. Once the particle filter 16 has been regenerated completely, the secondary air supply 18 is shut down again and the internal combustion engine 10 is again operated at a stoichiometric combustion air ratio λ_{E}=1 in a renewed loading phase I. The combustion air ratio λ_{E} is represented by a solid line in FIG. 3, the air mixing ratio λ_{M} downstream from the introduction point 20 is represented by a dotted line, and the secondary air introduced through the secondary air supply 18 is represented by a dashed line.

### LIST OF REFERENCE NUMERALS

10 internal combustion engine
12 exhaust gas duct
14 three-way catalyst
16 particle filter
18 secondary air supply
20 introduction point
22 first lambda probe
24 second lambda probe
26 intake duct
28 compressor
30 control unit
32 turbocharger
34 throttle valve
36 charge air cooler
38 turbine
40 drive shaft
42 secondary air valve
44 secondary air line
46 signal line
48 secondary air pump
λ_{E} combustion air ratio of the internal combustion engine
λ_{M} air mixing ratio in the exhaust gas duct downstream from the introduction of secondary air
T_{EG} temperature of the exhaust gas
T_{PF} temperature of the particle filter
T_{R} regeneration temperature of the particle filter
T_{SO} upper threshold temperature
T_{PF} change in temperature of the particle filter during regeneration

1. A method for exhaust gas aftertreatment of an internal combustion engine having an exhaust gas duct and a three-way catalyst arranged in the exhaust gas duct, a particle filter arranged downstream from the three-way catalyst, and a secondary air supply, comprising the following steps:
operating the internal combustion engine at a stoichiometric combustion air ratio (λ_{E}=1), wherein the soot particles formed by combustion are retained in the particle filter,
determining a load status of the particle filter,
initiating regeneration of the particle filter when the need for regeneration of the particle filter is detected on determining the charge state,
raising the exhaust gas temperature (T_{EG}) in a heating phase by operating the internal combustion engine with a rich combustion air ratio (λ_{E}<1) which is below the stoichiometric ratio while at the same time introducing secondary air into the exhaust gas duct upstream from the particle filter, wherein the unburned fuel components are exothermically reacted with the secondary air in the exhaust gas duct or on the particle filter until achieving a regeneration temperature (T_{R});
regenerating the particle filter, wherein the internal combustion engine is operated at a stoichiometric combustion air ratio (λ_{E}=1), and secondary air is introduced into the exhaust gas duct, so that an exhaust gas (λ_{M}>1), which exceeds the stoichiometric ratio, is formed downstream from the secondary air inlet, and
regulating the amount of secondary air that is introduced into the exhaust gas duct by a lambda probe downstream from an introduction point for the secondary air and upstream from the particle filter.

2. The method according to claim 1, further comprising establishing a stoichiometric air mixing ratio (λ_{M}=1) in the exhaust gas duct downstream from the three-way catalyst and upstream from the particle filter by introduction of secondary air during the heating phase.

3. The method according to claim 1, further comprising determining a temperature (T_{PF}) of the particle filter, and during the regeneration phase, keeping the temperature (T_{PF}) above the regeneration temperature (T_{R}) of the particle filter.

4. The method according to claim 1, further comprising stopping the introduction of secondary air upon reaching an upper threshold temperature (T_{SO}).

5. The method according to claim 3, further comprising increasing or decreasing the amount of secondary air injected into the exhaust gas duct as a function of a change in temperature (ΔT_{PF}) of the particle filter.

6. The method according to claim 1, further comprising increasing the amount of secondary air injected into the exhaust gas duct with an increase in regeneration of the particle filter.

7. The method according to claim 1, wherein, for regeneration of the particle filter, the particle filter is switched between the heating phase and the regeneration phase several times in alternation.

8. The method according to claim 1, further comprising keeping the temperature of the particle filter during regeneration within a temperature window between the regeneration temperature (T_{R}) and an upper threshold temperature (T_{SO}).

9. The method according to claim 8, wherein the temperature window is in the range of 600° C. to 750° C.

10. The method according to claim 1, further comprising regulating the amount of secondary air so that, during regeneration of the particle filter, an air mixing ratio (λ_{M}) of 1.05 to 1.4, preferably of 1.1 to 1.25, is established upstream from the particle filter.

11. The method according to claim 1, further comprising regulating the amount of secondary air so that a stoichiometric exhaust gas is established downstream from the particle filter.

12. The method according to claim 1, further comprising ending the heating phase only when the particle filter has reached a temperature of at least 30° C. above the regeneration temperature of the particle filter.

13. The method according to claim 1, wherein the secondary air is obtained from an intake duct of the internal combustion engine downstream from a compressor and is introduced into the exhaust gas duct.

14. A control unit for an internal combustion engine, having a computer-readable program algorithm for controlling the method according to claim 1.

15. A device for exhaust gas aftertreatment of an internal combustion engine having an exhaust gas duct, a three-way catalyst arranged in the exhaust gas duct and a particle filter arranged downstream from the three-way catalyst in the exhaust gas duct and having a secondary air supply, wherein an introduction point for the secondary air from the secondary air source is provided between the three-way catalyst and the particle filter, and also having a first lambda probe arranged upstream from the three-way catalyst and a second lambda probe arranged downstream from the introduction point and upstream from the particle filter, wherein the device is equipped to carry out a method according to claim 1.
